(19) United States
(12) Patent Application Publication
(10) Pub. No.: US 2025/0180048 A1
(43) Pub. Date: Jun. 5, 2025

(54) DEVICE FOR VIBRATION-DAMPED FASTENING OF A WORKPIECE

(71) Applicant: Siemens Mobility GmbH, München (DE)

(72) Inventors: Stefan Landkammer, Hilpoltstein (DE); Christoph Seefried, Zirndorf (DE); Sergius Ehmann, Ansbach (DE)

(21) Appl. No.: 18/835,112

(22) PCT Filed: Dec. 28, 2022
(86) PCT No.: PCT/EP2022/087951

§ 371 Date: Aug. 1, 2024

(30) Foreign Application Priority Data
Feb. 1, 2022 (DE) 10 2022 201 044.2

(51) Int. Cl. F16B 5/02; B61D 17/00

(52) U.S. Cl. CPC F16B 5/0241; B61D 17/00

(57) ABSTRACT

A device releasably fastens to a workpiece. The device contains a screw and the workpiece is fastened by use of a through-bore for passing the screw. The device contains elastically deformable perforated plates, which each have a through-bore for passing the screw through and thus can be aligned with the workpiece and can be placed against the workpiece such that the screw can be passed through the through-bore of the workpiece and through the through-bore of the first perforated plate and through the through-bore of the second perforated plate. The workpiece, around the first perforated plate, has a predefined free space in the radial direction relative to the axis of the through-bore through the first perforated plate in the predefined, intended assembly position and in a relaxed state of the first perforated plate, such that the first perforated plate can deform elastically in the radial direction to a predefined extent.

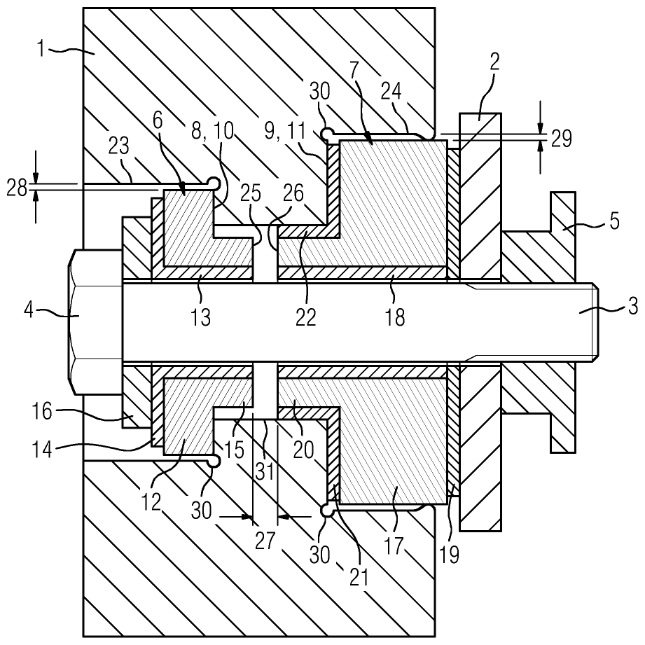

The invention relates to a device for releasable fastening of a workpiece, comprising a screw or a threaded rod and the workpiece to be fastened with a through-bore for passing the screw or the threaded rod through.

Workpieces in non-damped regions of vehicles, for example cladding parts on chassis of rail vehicles, are exposed to non-damped impacts, vibrations or oscillations with a high number of cycles. Therefore, in particular workpieces composed of plastics with low fatigue strengths, as are used in particular in the case of generatively manufactured workpieces, have not been used in these regions. Conventional screw connections for fastening of such workpieces, which from the very beginning already introduce local stress peaks into the plastics component, are additionally responsible for the fact that the loadings cannot be withstood, since material damage and crack formation through to breakage are expected even as a result of low cyclic loadings.

The invention is based on the object of increasing the availability of workpieces in non-damped regions of vehicles.

The object is achieved by the subject matter of independent patent claim 1. Developments and refinements of the invention are found in the features of the dependent patent claims.

A device according to the invention for releasable fastening of a workpiece comprises a screw or a threaded rod, the workpiece to be fastened and also at least two elastically deformable perforated disks which each have a through-bore for passing the screw or the threaded rod through. The workpiece to be fastened is referred to below only as the workpiece. It has a through-bore for passing the screw or the threaded rod through and a first abutment surface for abutment of a first perforated disk and a second abutment surface for abutment of a second perforated disk on both sides of the through-bore. The workpiece is suitably designed to receive the first perforated disk, bearing against the first abutment surface, and the second perforated disk, bearing against the second abutment surface, in the region of its through-bore in respectively predefined, intended mounting positions in such a way that the through-bores of the workpiece and of the first perforated disk and of the second perforated disk are arranged at least partially overlapping, with the result that the screw or the threaded rod is able to be passed through the through-bore of the workpiece and through the through-bore of the first perforated disk and through the through-bore of the second perforated disk. In addition, the workpiece is designed in such a way that it has a predefined free space around the first perforated disk in the radial direction with respect to the axis of the through-bore through the first perforated disk in the predefined, intended mounting position of the first perforated disk around the first perforated disk and in a relaxed state of the first perforated disk, with the result that the first perforated disk can elastically deform in the radial direction to an at least predefined extent. Equally, the workpiece has a predefined free space around the second perforated disk in the radial direction with respect to the axis of the through-bore through the second perforated disk in the predefined, intended mounting position and in a relaxed state of the second perforated disk, with the result that the second perforated disk can elastically deform in the radial direction to an at least predefined extent.

The workpiece may be a cladding part for a vehicle, in particular for a rail vehicle, in particular for a chassis or a truck of the rail vehicle.

A vehicle according to the invention, in particular a rail vehicle, correspondingly comprises at least one device according to the invention for releasable fastening of a workpiece. In this case, the workpiece may be mounted in a non-sprung, non-damped region of the vehicle or at a location of the vehicle where it is exposed to high, cyclic operating loads, in particular vibrations or oscillations, in particular with a high number of cycles, and/or impacts. For example, it is arranged on or releasably fastened to a chassis or truck of the vehicle. For example, the workpiece is a panel or a cladding part, in particular for non-damped regions of the vehicle, such as a cover for a chassis or truck of the vehicle.

The workpiece is releasably fastened to a component, in particular of the vehicle, for example to a frame of a chassis of the vehicle, by means of the screw or the threaded rod, which can also be referred to as threaded bolt. It is screwed to the component. To produce this screw connection, the component itself may have a bore with an internal thread that is complementary to the external thread of the screw or of the threaded rod or it has a through-bore and the screwing is effected by means of an additional threaded member, for example a nut. The screw can thus either be in the form of a through bolt with appropriate threaded member or of a screw or stud bolt, the component then having an internal thread that is complementary to the external thread of the screw and thus itself being a threaded member. Analogously, in the case of a threaded rod, a further threaded member is used instead of the screw head. As a result of the screwing, a preload acting axially with respect to the through-bore of the workpiece is applied to the workpiece with the interposition of the perforated disks between the screw head or the threaded member and the further threaded member.

This axial preload elastically deforms the perforated disks. For this purpose, they each comprise an elastic material, in particular an elastomer, for example rubber. This ensures an areal abutment of the perforated disks against the respective abutment surfaces and a uniform force introduction into the workpiece. At the same time, the elastic material serves for vibration damping and/or spring action.

The workpiece, for its part, is produced from another material. It comprises, in particular, a plastic, for example a polymer, which may also have low fatigue strengths. The fastening according to the invention enables the use of such materials.

According to one development, the workpiece is produced from a plastic by means of a generative, in particular additive, layerwise manufacturing method. Amorphous materials with good thermoplastic processability lend themselves for additive manufacturing. Here, the workpiece may be produced in layerwise fashion at least partially with layers having a radial directional component or even in the axial direction with respect to the through-bore, with the result that a force introduction by the perforated disks mutually preloaded against the workpiece by means of the screw or the threaded rod is distributed over various layers.

During the mounting of the device, the workpiece is oriented with respect to a component to which it is intended to be fastened, in particular at a location with high, cyclic operating loads, for example on a frame of a chassis of a vehicle. The first and second perforated disk each have a bearing surface for abutment against the respective abutment surfaces of the workpiece. They are for their part correspondingly oriented with respect to the workpiece, and placed on the workpiece, in such a way that the first perforated disk bears against the first abutment surface of the workpiece by way of the first bearing surface and the second perforated disk bears against the second abutment surface of the workpiece by way of the second bearing surface. In the respectively predefined, intended mounting positions, the through-bores of the workpiece and of the first and of the second perforated disk are arranged at least partially overlapping and the screw or the threaded rod is passed through the through-bore of the workpiece and through the through-bores of the first and of the second perforated disk. In this case, in a relaxed state of the first perforated disk, a predefined free space in the radial direction with respect to the axis of the through-bore through the first perforated disk around the first perforated disk is provided, with the result that the first perforated disk can elastically deform in the radial direction to an at least predefined extent. Analogously, in a relaxed state of the second perforated disk, a predefined free space in the radial direction with respect to the axis of the through-bore through the second perforated disk around the second perforated disk is provided, with the result that the second perforated disk can elastically deform in the radial direction to an at least predefined extent.

The workpiece to be fastened has, for example, a wall through which the through-bore passes. The wall thickness is suitably selected. The first abutment surface is formed on a first side of the wall and the second abutment surface is formed on a second side of the wall opposite the first side and facing away from the first side. The first and the second abutment surfaces are thus arranged on different sides of the wall and directed in opposite directions, with the result that the first perforated disk bears against the first side of the wall and the second perforated disk bears against the second side of the wall.

The abutment surfaces are in particular complementary to the bearing surfaces, for example in each case flat. The first perforated disk abuts areally, in particular fully areally, against the first side of the workpiece. Equally, the second perforated disk abuts areally, in particular fully areally, against the second side of the workpiece. The abutment and bearing surfaces may furthermore also be beveled, for example in the form of a cone or truncated cone, or even curved, for example in the form of a ball segment. The first perforated disk is able to be preloaded against the first side of the workpiece by means of a screw connection with the involvement of the screw or the threaded rod. At the same time, during the mounting the second perforated disk is preloaded against the second side of the workpiece by means of the screw connection by means of the screw or the threaded rod.

The axes of the through-bores through the workpiece and through the first and second perforated disks may be coincident. The diameter of the through-bore through the workpiece may be greater than the diameters of the through-bores through the perforated disks. In the case of coincident axes, the through-bores of the perforated disks then overlap the through-bore through the workpiece. In the case of equal diameters, the first and the second perforated disk may be oriented in such a way that their through-bores are aligned. The through-bore through the workpiece for passing the screw or the threaded rod through in particular has a diameter which is dimensioned with respect to the screw or threaded rod such that the workpiece is free from contact with the screw or the threaded rod, and this is the case both in the stress-free state of the perforated disks and in the preloaded state during the operation of the device and thus with oscillation input.

For the mounting, the workpiece may, for example, be fastened to the component in the order below. A screw head of the screw or a threaded member, for example a nut, clamp the first perforated disk against the workpiece. The second perforated disk bears against the other side of the workpiece. Said second perforated disk is preloaded against the workpiece by means of the component with an internal thread, into which an external thread of the screw engages. As an alternative, the component is preloaded against the second perforated disk and against the workpiece, between the second perforated disk and a further threaded member, for example a nut. To this end, the component then also has a through-bore.

According to one development of the invention, the workpiece has a first cutout for receiving the first perforated disk, wherein a first base surface of the first cutout forms the first abutment surface for abutment of the first perforated disk and wherein the first cutout is designed in such a way that side surfaces of the first cutout have a predefined spacing greater than zero to the first perforated disk in the predefined, intended mounting position and in the relaxed state of the first perforated disk. Analogously, the workpiece may have a second cutout for receiving the second perforated disk, wherein a second base surface of the second cutout forms the second abutment surface for abutment of the second perforated disk and wherein the second cutout is designed in such a way that side surfaces of the second cutout have a predefined spacing greater than zero to the second perforated disk in the predefined, intended mounting position and in the relaxed state of the second perforated disk.

The first and/or the second cutout may be in the form of a blind bore. In the case of a first and/or second perforated disk of circular cross section, the first cutout in the form of a blind bore has an inner diameter which is a predefined extent greater than an outer diameter of the first perforated disk of circular cross section in a relaxed state. Equally, the second cutout in the form of a blind bore may have an inner diameter which is a predefined extent greater than an outer diameter of the second perforated disk of circular cross section in a relaxed state. The axes of the first and/or second cutout are coincident with the axes of the perforated disks in the predefined mounting position of the perforated disks. The axes of the respective through-bores are then also identical. The circular base surfaces of the blind bore-like cutouts form the abutment surfaces for abutment of the perforated disks, that is to say a first base surface of the first cutout forms the first abutment surface for abutment of the first perforated disk and/or a second base surface of the second cutout forms the second abutment surface for abutment of the second perforated disk. The lateral surfaces of the blind bores may correspondingly form the side surfaces of the cutouts. The cutouts are thus delimited by the respective abutment surfaces and side surfaces.

In a relaxed state of the first perforated disk, that is to say a stress-free and non-deformed state of the first perforated disk, the first cutout of the workpiece is dimensioned with respect to the first perforated disk to be received such that the first perforated disk can elastically expand radially by a predefined extent from the relaxed state to a deformed state brought about by an axial preload. The same may apply to the second perforated disk: the second cutout of the workpiece is dimensioned with respect to the relaxed second perforated disk such that said second perforated disk can elastically expand radially by a predefined extent from the relaxed state to a deformed state brought about by an axial preload. In this case, the axial preload may be introduced onto the first and/or second perforated disk by means of the screw or the threaded rod.

As above, it would also be possible here to say that the first cutout is complementary to the first perforated disk and/or that the second cutout is complementary to the second perforated disk.

According to one embodiment, the first and/or second cutouts are so deep that the first and/or second perforated disk can be completely received. The first and/or second perforated disks are recessed in the respective cutout in the case of abutment against the respective abutment surface. It is for example possible for that side of the first and/or second perforated disk which faces away from the respective bearing surface and is opposite it to run flush with the workpiece or for the side surfaces of the respective cutout to protrude beyond the first and/or second perforated disk, with the result that for example a screw head or threaded rod bearing against the first perforated disk is also at least partially received in the first cutout.

As an alternative, the first and/or second cutout may be designed with respect to the first and/or second perforated disk in such a way that the first and/or second perforated disk at least partially protrudes beyond the correspondingly respective first and/or second cutout. The thickness of the first and/or second perforated disk between its bearing surface and the opposite side is for example greater than the depth of the first and/or second cutout, in particular at the edge of a first and/or second perforated disk designed in this way it has a greater thickness than the height of the correspondingly respective side surfaces of the cutout. The predefined free space in the radial direction with respect to the axis of the through-bore through the first and/or second perforated disk in the predefined, intended mounting position and in a relaxed state of the first and/or second perforated disk around the first and/or second perforated disk may extend over the entire thickness of the elastic part of the first and/or second perforated disk from the first and/or second bearing surface as far as the side thereof, opposite the corresponding first and/or second bearing surface, for example as far as a first and/or second washer, of the first and/or second perforated disk, with the result that the first and/or second perforated disk can expand radially over this entire thickness.

By contrast, according to a further refinement of the invention, the workpiece and the first perforated disk are designed with respect to one another in such a way that a spacing between the first perforated disk and the workpiece in the radial direction with respect to the axis of the through-bore through the first perforated disk in the predefined, intended mounting position and in a relaxed state of the first perforated disk is zero or the first perforated disk is radially preloaded by the workpiece in the radial direction with respect to the axis of the through-bore through the first perforated disk in the predefined, intended mounting position and in a state in which the first perforated disk is not preloaded by the screw or threaded rod. The first perforated disk is then radially clamped in the workpiece. The clamping is effected merely in certain portions. That is to say only a portion of the first perforated disk, in particular of the elastically deformable part of the first perforated disk, is radially clamped by the workpiece. This portion is in particular small in comparison to that region of the first perforated disk, in particular of the elastically deformable part of the first perforated disk, which can freely radially expand, with the result that the first perforated disk can still elastically deform in the radial direction to an at least predefined extent. In the same way, the workpiece and the second perforated disk may be designed with respect to one another in such a way that a spacing between the second perforated disk and the workpiece in the radial direction with respect to the axis of the through-bore through the second perforated disk in the predefined, intended mounting position and in a relaxed state of the second perforated disk is zero or the second perforated disk is radially preloaded by the workpiece in the radial direction with respect to the axis of the through-bore through the second perforated disk in the predefined, intended mounting position and in a state in which the second perforated disk is not preloaded by the screw or threaded rod, and thus is held radially clamped in the workpiece in certain portions. Workpiece and first and/or second perforated disk thus have a transition fit or interference fit in the region for receiving at least the elastically deformable part of the first and/or second perforated disk. In particular, a spacing between the side surfaces of the first and/or second cutout and at least the elastically deformable part of the first and/or second perforated disk is equal to or smaller than zero (clamping) in the predefined, intended mounting position and in a state in which the first and/or second perforated disk is not preloaded by the screw or threaded rod. There is furthermore a free space in the radial direction around the first and/or second perforated disk, with the result that the first and/or second perforated disk can elastically deform in the radial direction to an at least predefine extent. The predefined free space in the radial direction with respect to the axis of the through-bore through the first and/or second perforated disk in the predefined, intended mounting position and in the relaxed state of the first and/or second perforated disk thus does not extend over the full thickness and/or extent of at least the elastic part of the first and/or second perforated disk between its first and/or second bearing surface and that side of the perforated disk which is opposite the corresponding first or second bearing surface. This may, for example, be realized by at least one or in particular multiple lugs which project into the cutout or differently shaped projections in the side surfaces of the first and/or second cutout. A ring-shaped elevation, acting as a projection, in the side surfaces should also be considered to be encompassed here. In addition or as an alternative, functionally identical radial protrusions of the first and/or second perforated disk are also conceivable.

As a result of this clamping, a rotation of the first and/or second perforated disk and of the workpiece with respect to one another is additionally impeded or prevented.

With the workpiece, the perforated disks and the screw or the threaded rod, the device according to the invention comprises multiple individual parts or components, and therefore mention could also be made of a construction kit or mounting kit for releasable, vibration-damping connection of the workpiece to the component or a releasable, vibration-damped attachment of the workpiece to the component.

The invention simplifies the attachment of workpieces, in particular having low fatigue strengths, in non-damped regions of vehicles and at the same time increases the service life thereof. The operational capability, functionality and suitability, in particular of additively manufactured workpieces in non-damped regions of vehicles is provided as a result and thus the availability of workpieces is improved overall. Operating loads are introduced in a distributed manner, in order to reduce the stress input on account of screw connections in additive workpieces. Further advantages of the invention are:
the perforated disks as damping elements hug the contour of the workpiece and thus generate a uniformly distributed holding force in all spatial directions and a holding force distributed over a larger area, with therefore smaller area loads;
a uniformly distributed force input ensures lower local stress peaks, leading to a longer service life;
vibration damping is enabled in all 3 spatial directions;
in the case of additive workpieces, the force introduction is distributed over various layers, as a result of which there is a lower risk of critical loadings at layer transitions with low strength.

In addition, the disadvantages are overcome that in the case of customary screw connections local stresses are introduced into the component, which are even further increased by the operating loads. Screw connections of plastics parts were therefore often the strength-limiting or service life-determining element on components. Screw connection points were therefore generally the critical, service life-determining regions for additively manufactured components because stresses are introduced into the component in a locally concentrated manner. In particular, regions exposed to impacts and vibrations, for example on the truck of a rail vehicle, were hitherto critical for the use of additively manufactured components. The invention enables the use of many further, different workpiece materials. Cyclic operating loads, vibrations and impacts can also be realized without any local material damage due to avoided stress peaks.

The developments described below serve to further improve the mentioned aspects.

Thus, according to a further development, at least the first perforated disk has a first sleeve in a through-bore through an elastically deformable part of the first perforated disk for passing the screw or the threaded rod through, said first sleeve limiting a deformation of the elastically deformable part of the first perforated disk in the radial direction toward the axis of the through-bore of the first perforated disk. Analogously, the second perforated disk may also have a second sleeve in a through-bore through an elastically deformable part of the second perforated disk for passing the screw or the threaded rod through, said second sleeve limiting a deformation of the elastically deformable part of the second perforated disk in the radial direction toward the axis of the through-bore of the second perforated disk. The first and/or second sleeve is firm in comparison to the elastic material of the elastically deformable part of the first and/or second perforated disk and is in particular manufactured from a metal or from a metal alloy. It may be tubular and hollow-cylindrical for passing the screw or the threaded rod through. The respective sleeve frees a space for passing the screw or the threaded rod through and thus delimits the through-bore through the respective perforated disk for passing the screw or the threaded rod through. The screw or threaded rod is then passed through the sleeve in the respective perforated disk. The first and/or second sleeve may be cohesively connected to the respective elastically deformable part of the first and/or second perforated disk and thus form a so-called rubber-metal element with the elastically deformable part. The relatively stiff first and/or second sleeve counteracts an expansion under an axial preload of the elastically deformable part of the first and/or second perforated disk in the radial direction, that is to say into the respective through-bore, and limits said expansion.

According to a further development, provision is made for the first sleeve to protrude to a predefined extent greater than zero beyond the first bearing surface of the first perforated disk for abutment of the first perforated disk against the first abutment surface of the workpiece in such a way that the first sleeve projects to a predefined extent greater than zero into the through-bore in the workpiece in the predefined, intended mounting position of the first perforated disk. Analogously, it is alternatively or additionally possible for the second sleeve to protrude to a predefined extent greater than zero beyond the second bearing surface of the second perforated disk for abutment of the second perforated disk against the second abutment surface of the workpiece in such a way that the second sleeve projects to a predefined extent greater than zero into the through-bore in the workpiece in the predefined, intended mounting position of the second perforated disk.

In order to receive the first and/or second sleeve, the diameter of the through-bore of the workpiece is at least the same size as or greater than the outer diameter of the first and/or second sleeve. The inner diameter of the first and/or second sleeve and thus the diameter of the through-bore of the first and/or second perforated disk is, as already mentioned above, at least suitably selected for passing the screw or threaded rod through.

According to a further development, both the first perforated disk has a first sleeve and the second perforated disk has a second sleeve. In this case, in the predefined, intended mounting position of the first and of the second perforated disk, the first sleeve and/or the second sleeve project into the through-bore of the workpiece. It is thus possible for only one sleeve to protrude beyond the bearing surface of the perforated disk and to project into the through-bore of the workpiece or both sleeves protrude beyond the respective bearing surface of the perforated disk and project into the through-bore of the workpiece.

In a further development, at least the first perforated disk has a, in particular hollow-cylindrical, first protrusion of the elastically deformable part, which first protrusion protrudes to a predefined extent greater than zero beyond the first bearing surface of the first perforated disk for abutment of the first perforated disk against the first abutment surface of the workpiece, with the result that the first protrusion projects to a predefined extent greater than zero into the through-bore in the workpiece in the predefined, intended mounting position of the first perforated disk. The second perforated disk may also have such a, in particular a hollow-cylindrical, second protrusion of the elastically deformable part of the second perforated disk, which second protrusion protrudes to a predefined extent greater than zero beyond the second bearing surface of the second perforated disk, with the result that the second protrusion projects to a predefined extent greater than zero into the through-bore in the workpiece in the predefined, intended mounting position of the second perforated disk. The first and/or second protrusion is in particular produced from the same elastically deformable material as the respective, elastically deformable part of the first and/or second perforated disk and is connected thereto in a joint-free manner. In particular, the elastically deformable part of the first and/or second perforated disk and the respective first and/or second protrusion are of monolithic form. The first and/or second protrusion has a through-bore for receiving the screw or threaded rod, which in particular has the same inner diameter as the corresponding elastically deformable part of the first and/or second perforated disk. Equally, the first and/or second sleeve may be framed by the respectively corresponding first and/or second protrusion. The first and/or second protrusion thus delimits the first and/or second perforated disk inwardly toward the axis of the through-bore and the inner diameter of the first and/or second protrusion is suitably selected for passing the screw or threaded rod through or the corresponding first and/or second sleeve is engaged in the first and/or second protrusion and, for their part, delimits the respective through-bore of the first and/or second perforated disk for receiving the screw or threaded rod inwardly toward the axis of the through-bore.

As already mentioned above, the through-bore of the workpiece may be greater than the through-bore of the perforated disks, in particular for receiving sleeve and/or protrusion.

If a sleeve is provided, this may also protrude beyond the protrusion, with the result that the sleeve projects further than the protrusion into the through-bore of the workpiece. Sleeve and protrusion may alternatively terminate flush with one another, such that an end side of the perforated disk, said end side being arranged in the through-bore of the workpiece, is formed by sleeve and protrusion.

Many combinations are thus conceivable:

both the first and the second perforated disk may each be formed without a sleeve or protrusion or only one perforated disk has a sleeve and/or protrusion, the other perforated disk being free from sleeve and protrusion, or one perforated disk has only a sleeve and the other perforated disk has only a protrusion or one perforated disk has a sleeve and a protrusion and the other perforated disk has only a protrusion without a sleeve or both perforated disks have both a sleeve and a perforated disk. All combinations should be considered to be expressed and encompassed by the and/or conjunctions used hitherto and henceforth.

A wall thickness of the workpiece in the region of the through-bore through the workpiece between the first abutment surface and the second abutment surface is coordinated with the first and/or the second perforated disks, which project into the through-bore of the workpiece, in such a way that, in the predefined, intended mounting position of the first and of the second perforated disk and in the relaxed state of the first and of the second perforated disk, a predefined spacing greater than zero in the axial direction is formed between the two opposite end sides of the first and second perforated disks in the region of the through-bore through the workpiece. If one of the two perforated disks, for example the second perforated disk, does not have a sleeve and/or protrusion projecting into the through-bore of the workpiece, the bearing surface thereof forms the end side opposite the end side, arranged in the through-bore of the workpiece, of the sleeve and/or protrusion of the other perforated disk, for example the first perforated disk. If, by contrast, both the first and the second perforated disk each have a sleeve and/or a protrusion, the end sides thereof arranged in the through-bore of the workpiece lie opposite one another and form the predefined spacing greater than zero in the axial direction. Mention could also be made of an axial gap in the through-bore of the workpiece between the end sides of the first and of the second perforated disk.

In a further development, the first and the second perforated disks are designed in such a way that the spacing of predefined extent greater than zero between the opposite end sides of the first and second perforated disks in the region of the through-bore in the predefined, intended mounting position of the first and of the second perforated disk and in the relaxed state of the first and of the second perforated disk can be created by the application of a predefined preload by means of the screw or the threaded rod and a resultant elastic deformation of the first and of the second perforated disk. The spacing or gap can be produced and thus predefined by selection of the constructional configuration, in particular of the dimensioning, and of the materials and thus their physical properties of the first and of the second perforated disk.

According to a further development of the device,
the axial spacing between the two opposite end sides of the first and second perforated disk in the region of the through-bore through the workpiece and
the free space around the first and/or second perforated disk in the radial direction with respect to the axis of the through-bore through the workpiece in the predefined, intended mounting position of the first and/or second perforated disk and in a relaxed state of the first and/or second perforated disk.
   are predefined in mutual dependence and in further dependence on
the strength, for example a Shore hardness or comparable strength values, in particular at least of the elastically deformable part, of the first and/or second perforated disk and
an axial preload force applied by means of the screw or the threaded rod.

The coordination is effected in particular such that a predefined elastic deformation of the first and/or second perforated disk in the radial direction and/or in the axial direction is not exceeded. The axial preload force applied by means of the screw or the threaded rod is predefined. It is predefined in such a way that secure mounting is also ensured during operation.

For example, the spacing between opposite end sides of the first and second sleeve, said end sides being arranged in the through-bore of the workpiece, and the free spaces in the radial direction around the first and second perforated disk with respect to the axes of the through-bores through the first and the second perforated disk are predefined in mutual dependence and in further dependence on the strengths of the first and second perforated disk and on the predefined preload force applied by means of the screw or the threaded rod.

In a further development, the spacing from the side surfaces of the first cutout to the first perforated disk in the predefined, intended mounting position and in the relaxed state of the first perforated disk is predefined in dependence on the strength of the first perforated disk in such a way that, in the case of a predefined preload force applied by means of the screw or the threaded rod, the first perforated disk elastically deformed thereby bears against the side surfaces of the first cutout. Analogously, the spacing from the side surfaces of the second cutout to the second perforated disk in the predefined, intended mounting position and in the relaxed state of the second perforated disk is predefined in dependence on the strength of the second perforated disk in such a way that, in the case of a predefined preload force applied by means of the screw or the threaded rod, the second perforated disk elastically deformed thereby bears against the side surfaces of the second cutout. As already mentioned above, this can be effected in further dependence on the spacing between the opposite end sides of the first and second sleeve, said end sides being arranged in the though-bore of the workpiece, and possibly in further dependence on the strengths, for example Shore hardnesses, of the first and second perforated disk, or at least of the respective elastically deformable parts of the first and second perforated disk, and on the predefined preload force applied axially by means of the screw or the threaded rod.

Further advantages of the invention, in particular with the presence of at least one sleeve, are an adjustable ratio of the preload force of the screw connection to the pressing force of the perforated disks over the spacing (clamping gap) between the opposite end sides of the first and second perforated disk, said end sides being arranged in the through-bore of the workpiece. The preload force of the screw connection by means of the screw or threaded rod and thus the clamping force can be increased up to the load limit of the screw or threaded rod. There is no longer a problem because of settling loss of the plastic of the workpiece. Additional screw locking means such as wedge lock washers, spring washers or similar may be used independently of the settling behavior of the additive plastic of the workpiece.

For further improvement, the developments of the device according to the invention that follow are proposed.

Thus, according to a further development, provision is made for at least the first perforated disk to comprise a firm first washer for abutment of a screw head of the screw or for abutment of a threaded member, for example a nut, for screwing with the threaded rod, which first washer is arranged, in the predefined, intended mounting position of the first perforated disk, on a side of the first perforated disk opposite the first bearing surface of the first perforated disk. The first washer has a high strength and is thus rigid in comparison to the elastic part of the first perforated disk. It in particular comprises a metal or a metal alloy and counteracts a deformation of the elastically deformable part of the first perforated disk in the axial direction toward the first washer and limits said deformation. In addition, the first washer brings about a uniform force introduction and force distribution of a preload force applied by the screw head or the threaded member into the first perforated disk. It thus serves for an improved force introduction, distributed in terms of area, into the first perforated disk. The first washer is firmly, in particular cohesively, connected, for example adhesively bonded, to the elastic part of the first perforated disk. Analogously, the second perforated disk may comprise a firm second washer, which is in particular cohesively connected to the elastic part of the second perforated disk and is in particular composed of a metal or of a metal alloy, for abutment of a screw head of the screw or for abutment of a threaded member, for example a nut, for screwing with the threaded rod, which second washer is arranged, in the predefined, intended mounting position of the second perforated disk, on a side of the second perforated disk opposite the second bearing surface of the second perforated disk.

In a further development, the first and/or second washer extends over the entire surface of the corresponding first and/or second perforated disk, said surface being opposite the corresponding first and/or second bearing surface.

In a further development, the first washer and the first sleeve are firmly, in particular cohesively, connected to one another, in particular in a joint-free manner. The first sleeve and the first washer may also be of monolithic form. A main body of the first washer and of the first sleeve could thus be produced from a casting. The first washer could also be referred to as a radial collar of the first sleeve. The entire construction of first washer and first sleeve could be referred to as a hollow-cylindrical plug, axle sleeve or bushing. The second washer and the second sleeve may be shaped similarly.

Furthermore, provision may be made for at least also the first bearing surface of the first perforated disk to be firm. Analogously, the second bearing surface of the second perforated disk may also be firm. For this purpose, it is in turn possible for the first and/or second perforated disk to have a firm first and/or second ring washer which in particular comprises a metal or a metal alloy, is in particular manufactured from a metal or a metal alloy and is firmly, in particular cohesively, connected, for example adhesively bonded, to the corresponding elastically deformable part of the first and/or second perforated disk. The first and/or second ring washer then in each case forms the corresponding first and/or second bearing surface of the first and/or second perforated disk for abutment of the corresponding first and/or second perforated disk against the corresponding first and/or second abutment surface of the workpiece. Analogously to the first and/or second washer, the first and/or second ring washer in turn ensures a uniform force introduction into the respective perforated disk. As already mentioned above, the first and/or second bearing surface formed by the first and/or second ring washer is complementary to the corresponding first and/or second abutment surface of the workpiece for an areal abutment of the first and/or second perforated disk against the workpiece.

The first ring washer may also have a hollow-cylindrical first collar which projects at least partially into the through-bore in the workpiece in the predefined, intended mounting position of the first perforated disk. The first collar may thus serve as first outer sleeve for the first protrusion and at least partially surround the latter. It is intended for use in the through-bore of the workpiece and forms a fit therewith. Its outer diameter would then be only minimally smaller or the same size as the outer diameter of the through-bore of the workpiece in the region of the first collar. The first collar may also be cohesively connected, for example adhesively bonded, to the first protrusion of the elastically deformable part of the first perforated disk. In particular, the first collar is connected cohesively, in particular in a joint-free manner, to the first ring washer, in particular is shaped therefrom. Equally, the second ring washer may also have a hollow-cylindrical second collar which projects at least partially into the through-bore in the workpiece in the predefined, intended mounting position of the second perforated disk. The further described features regarding the first perforated disk are also analogously applicable to the second perforated disk.

The invention permits numerous embodiments. It will be explained in more detail on the basis of the figure below, in which one exemplary embodiment is illustrated.

In the figure, a device according to the invention for releasable vibration-damping connection of a workpiece 1 to a component 2 is illustrated schematically in partial section. The component 2 here is a chassis of a rail vehicle. The workpiece 1 is a cover or another cladding part for the chassis. It is releasably mounted and braced on the component 2 by means of a screw connection, in this case comprising a screw 3 with a screw head 4 and a cage nut as threaded member 5. The cage nut forms, as threaded member 5, the counterpart, provided with an internal thread, to the screw head 4 and is complementary to the screw 3.

The workpiece 1, and also the component 2, has a through-bore 31 for passing the screw 3 through. In addition, the device has two perforated disks 6 and 7 which, in the illustrated state in the predefined mounting position, bears against abutment surfaces 10 and 11 of the workpiece 1 in the region of the through-bore 31 through the workpiece 1 by way of their bearing surfaces 8 and 9.

In this case, the first perforated disk 6 comprises a vibration-damping, elastically deformable part 12, a first sleeve 13 and a first washer 14. The elastically deformable part 12 is produced from an elastomer, for example rubber.

The first washer 14 may be firmly connected to the elastically deformable part 12. It is arranged on a side of the first perforated disk 6 opposite the first bearing surface 10 of the first perforated disk 6 and thus, in the mounting position shown, on that side of the first perforated disk 6 which faces away from the first bearing surface 8 of the workpiece 1 and the through-bore 31 through the workpiece 1. Here, the screw head 4 bears against the first washer 14 of the first perforated disk 6 with the interposition of lock washers 16. By way of the first washer 14, the forces acting on the first perforated disk 6 by the screw head 4 are uniformly distributed into the elastically deformable part 12.

In this exemplary embodiment, the first sleeve 13 is shaped from the first washer 14 or vice versa, i.e. the first sleeve 13 is connected to the first washer 14 in a joint-free manner or is of monolithic form therewith. The first sleeve 13 is tubular to allow the screw 3 to pass through and extends at least partially into the through-bore 31 of the workpiece 1 in the mounted state of the device—it protrudes to an extent greater than zero beyond the first bearing surface 8 and thus projects with the protruding region into the through-bore 31. The first sleeve 13 is, just like the first washer, produced from a metallic material and counteracts a deformation of the elastically deformable part 12 of the first perforated disk 6 in the radial direction toward the axis of the through-bore 31 and limits said deformation. It may also be adhesively bonded to the elastically deformable part 12 of the first perforated disk 6.

The elastically deformable part 12 has the first protrusion 15. The first protrusion 15 also protrudes to an extent greater than zero beyond the first bearing surface and projects into the through-bore 31. In this exemplary embodiment, the first protrusion 15 is the same size as that region of the first sleeve 13 which protrudes beyond the first bearing surface 8. Here, the first protrusion thus forms, together with the first sleeve 13, the first end side 25 of the first perforated disk 6, said first end side projecting into the through-bore in the illustrated mounting position of the device. The first protrusion 15 is also of hollow-cylindrical shape. Its outer diameter is the same size as or smaller than the inner diameter of the through-bore 31—in this case a little smaller for a small radial clearance between through-bore 31 and first perforated disk 6. In addition to a clearance fit, a transition fit or interference fit is alternatively conceivable. The inner diameter of the first protrusion 15 is in turn approximately the same size as the outer diameter of the first sleeve 13.

The second perforated disk 7 comprises a vibration-damping, elastically deformable part 17, a second sleeve 18, a second washer 19 and a second ring washer 21 with a collar 22.

The second washer 19 is arranged on a side opposite the second bearing surface 9 of the second perforated disk 7 and thus, in the mounting position shown, on that side of the second perforated disk 7 which faces away from the second abutment surface 11 of the workpiece 1. Here, the cage nut as threaded member 5 bears against the second washer 19. Analogously to above, the second washer 19 transmits the arising forces of the threaded member 5 reliably to the underlying surface—in this case the elastic part 17 of the second perforated disk 7. However, in this exemplary embodiment the second washer 19 is not connected to the second sleeve 18. There is a small gap between the second sleeve 18 and the second washer 19. The second sleeve 18 and also the second washer 19 are each connected only to the elastically deformable part 17.

The second sleeve 18 also protrudes beyond the second bearing surface 11 and projects, in the mounted state, into the through-bore 31 through the workpiece 1. As in the case of the first perforated disk 6, the second perforated disk 7 also has a protrusion 20 of the elastically deformable part 17, said protrusion also projecting into the through-bore 31 and at least partially surrounding the second sleeve 18.

In addition, the second bearing surface 9 of the second perforated disk 7 is formed at least in certain portions by a washer 21 of ring-shaped cross section, which may in turn be connected to the elastic part 17, for example via an adhesive connection. The ring washer has a collar 22 which points away from the second washer 19 and thus in turn projects into the through-bore 31 and at least partially encloses the second protrusion 20. The collar 22 is correspondingly of tubular shape and can form a clearance fit or transition fit with the through-bore. Ring washer 21 and collar 22 can in turn be manufactured in one piece, for example as a pressed part or deep-drawn part.

In this exemplary embodiment, collar 22 and second protrusion 20 do not protrude as far as the second sleeve. Therefore, only the second sleeve 18 forms the second end side 26 of the second perforated disk 7, said second end side projecting into the through-bore 31 in the illustrated mounting position of the device.

In the predefined, intended mounting position and in a relaxed state of the perforated disks 6 and 7, that is to say without any axial preload applied by the screw connection by means of the screw 3 and the threaded member 5, a spacing 27 of the second end side 26 of the second sleeve 18 to the first end side 25 of the first perforated disk 6 amounts to a predefined extent greater than zero. This spacing 27, also referred to as clamping gap, will be discussed in more detail below.

On account of the type of construction shown here, the perforated disks 6 and 7 can be referred to as rubber-metal elements.

The workpiece 1 has a first cutout in the region of the through-bore 31 for receiving the first perforated disk 6 and a second cutout in the region of the through-bore 31 for receiving the second perforated disk 7. The base surface of the first cutout serves as first abutment surface 10 for abutment of the first perforated disk 6 by way of its bearing surface 8. The side surfaces 23 of the first cutout limit a possible radial expansion of the first perforated disk 6. They at least partially border the first perforated disk 6. In the region of the first abutment surface 10, the first side surfaces 23 have an undercut 30. Analogously, an undercut 30 is provided in the region where the base surface of the second cutout, which base surface as second abutment surface 11 is complementary to the second bearing surface 9 of the second perforated disk, abuts against the second side surfaces 24 of the second cutout.

Without undercuts 30, the cutouts could also be described as blind bores, having substantially flat bottoms as abutment surfaces, penetrated by the through-bore 31, and having inner diameters greater than the outer diameters of the perforated disks to be received. In the predefined, intended mounting position and in a relaxed state of the perforated disks 6 and 7, the axes of the blind bores and of the through-bore 31 through the workpiece, and also the through-bores through the perforated disks received and oriented centrally in the respective cutout, are coincident.

In order to enable free expansion in the radial direction of at least the elastically deformable parts 12 and 17 of the first and of the second perforated disk 6 and 7, there is a free space in the radial direction with respect to the axis of the through-bores through the perforated disks 6 and 7. Here, in the predefined, intended mounting position and in a relaxed state of the perforated disks 6 and 7, the first and second perforated disk 6 and 7 have a radial clearance in the respective cutouts in the workpiece 1. The spacings 28 and 29 between the first perforated disk 6 and the first side surface 23 and between the second perforated disk 7 and the second side surface 24 each have a predefined extent greater than zero.

This extent may in each case be selected such that, in the case of a predefined axial preload force applied by means of the screw 3 via the screw head 4 and the threaded member 5, the first and second perforated disks 6 and 7 elastically deformed radially thereby each bear against the corresponding first and second side surfaces 23 and 24 of the cutouts. The elastic deformation in the radial direction is brought about by the preload in the axial direction. The free radial expansion of the perforated disks 6 and 7 is then limited by the side surfaces 23 and 24 of the cutouts. The respective spacing 28 and 29 of the side surfaces 23 and 24 to the correspondingly received perforated disks 6 and 7 may be dimensioned, and coordinated with the dimensions and the strength of the perforated disks 6 and 7, in particular the elastically deformable parts thereof, in such a way that given a predefined axial preload by the screw connection the deformed perforated disks 6 and 7 bear against the respective side surfaces 23 and 24 under predefined stress. The preload force applied to the screw connection is correspondingly selected and determined in such a way that secure mounting of the device on the component is also ensured under predefined operating conditions over the service life. Here, the dimensioning of the spacings of the side surfaces 23 and 24 to the corresponding perforated disks 6 and 7 and the spacing 27 between the end sides 25 and 26 of the first and second perforated disk 6 and 7 (clamping gap) in the predefined, intended mounting position and in a relaxed state of the perforated disks 6 and 7 are coordinated with one another and in further dependence on the strength, in particular the Shore hardness, of the perforated disks 6 and 7 in such a way that given a predefined axial preload by the screw connection the clamping gap is closed, that is to say the end sides 25 and 26 bear against one another, possibly are pressed against one another under predefined stress, and the deformed perforated disks 6 and 7 bear against the respective side surfaces 23 and 24 under predefined stress. Here, the deformation of the washers, ring washer, of the screw and of the sleeves in the axial direction can be ignored on account of their greater strength or included in the calculation. The clamping gap, which is present in the predefined, intended mounting position and in a relaxed state of the perforated disks 6 and 7, between the opposite sleeve ends of the perforated disks 6 and 7, said sleeve ends being directed toward one another and facing one another, is closed by the axial preload by the screw connection by means of the screw 3 and the threaded member 5 and the elastic deformation of at least the elastically deformable parts of the perforated disks 6 and 7. In this case, a predefined elastic deformation in the axial direction of the perforated disks 6 and 7 is also not exceeded.

The device is depicted in the predefined mounting position in the figure, but without any preload by the screw connection. The perforated disks 6 and 7 are therefore illustrated still in the relaxed state.

Here, the first cutout is so deep that the first perforated disk 6 is completely received and recessed in it. Only the screw head 4 still projects to some extent out of the first cutout. By contrast, the depth of the second cutout is dimensioned with respect to the second perforated disk 7 in such a way that the second perforated disk 7 protrudes beyond it. The thickness of the second perforated disk 7 between its second bearing surface 9 and that surface of the second washer 19 which bears against the component 2 is greater than the depth of the second cutout and thus greater than the height of the second side surfaces 24 of the second cutout. Direct contact between component 2 and workpiece 1 is thus avoided. This is the case both in the relaxed state of the second perforated disk 7 and in the preloaded, mounted state of the second perforated disk 7.

In the region of the second cutout, the workpiece 1 additionally has an encircling projection 32 in the second side surfaces 24 for engagement with the second perforated disk 7. Second perforated disk 7 and projection 32 form an interference fit. In this way, the second perforated disk 7 is clamped in the second cutout and thus secured against rotation. Radial expansion of the second perforated disk 7 is therefore prevented only in the region of the projection. However, this region is small in comparison to the depth of the second cutout or to the height of the side surfaces 24 of the second cutout. In addition to a ring-shaped projection, punctiform clamping could also be effected by way of lug-like projections. The clamping prevents rotation of the second perforated disk 7 relative to the workpiece 1.

1-15. (canceled).

16. A device for releasable fastening of a workpiece having a through-bore formed therein, the device comprising:
a screw or a threaded rod for passing through the through-bore of the workpiece; and
at least two elastically deformable perforated disks each having a through-bore formed therein for passing said screw or said threaded rod through and said at least two elastically deformable perforated disks including a first perforated disk and a second perforated disk, wherein the workpiece has a first abutment surface for abutment of said first perforated disk and a second abutment surface for abutment of said second perforated disk on both sides of said through-bore of the workpiece, wherein the workpiece is configured to receive said first perforated disk, bearing against the first abutment surface, and said second perforated disk, bearing against the second abutment surface, in a region of the through-bore of the workpiece in respectively predefined, intended mounting positions such that the through-bores of the workpiece and of said first perforated disk and of said second perforated disk are disposed at least partially overlapping, with a result that said screw or said threaded rod is passed through the through-bore of the workpiece and through said through-bore of said first perforated disk and through said through-bore of said second perforated disk, and in that the workpiece has a predefined free space in a radial direction with respect to an axis of said through-bore through said first perforated disk in a predefined, intended mounting position and in a relaxed state of said first perforated disk around said first perforated disk, with a result that said first perforated disk can elastically deform in the radial direction to an at least predefined extent, and wherein the workpiece has a predefined free space in the radial direction with respect to an axis of said through-bore through said second perforated disk in the predefined, intended mounting position and in the relaxed state of said second perforated disk around said second perforated disk, with a result that said second perforated disk can elastically deform in the radial direction to an at least predefined extent.

17. The device according to claim 16, wherein:
the workpiece has a first cutout for receiving said first perforated disk, wherein a first base surface of the first cutout forms the first abutment surface for abutment of said first perforated disk and wherein the first cutout is configured such that side surfaces defining the first cutout have a predefined spacing greater than zero to said first perforated disk in the predefined, intended mounting position and in the relaxed state of said first perforated disk; and/or
the workpiece has a second cutout for receiving said second perforated disk, wherein a second base surface of the second cutout forms the second abutment surface for abutment of said second perforated disk and wherein the second cutout is configured such that side surfaces of the second cutout have a predefined spacing greater than zero to said second perforated disk in the predefined, intended mounting position and in the relaxed state of said second perforated disk.

18. The device according to claim 16, wherein:
said first perforated disk contains a tubular first sleeve for passing said screw or said threaded rod through said tubular first sleeve, said tubular first sleeve limiting a deformation of said first perforated disk in the radial direction toward the axis of said through-bore of said first perforated disk; and/or
said second perforated disk contains a tubular second sleeve for passing said screw or said threaded rod through said tubular second sleeve, said tubular second sleeve limiting the deformation of said first perforated disk in the radial direction toward the axis of said through-bore of said second perforated disk.

19. The device according to claim 18, wherein:
said tubular first sleeve protrudes beyond a first bearing surface of said first perforated disk for abutment against the first abutment surface of the workpiece such that said tubular first sleeve projects into the through-bore in the workpiece in the predefined, intended mounting position of said first perforated disk; and/or
said tubular second sleeve protrudes beyond a second bearing surface of said second perforated disk for abutment against the second abutment surface of the workpiece such that said tubular second sleeve projects into the through-bore in the workpiece in the predefined, intended mounting position of said second perforated disk.

20. The device according to claim 19, wherein a wall thickness of the workpiece between the first abutment surface and the second abutment surface is coordinated with said tubular first and second sleeves, which project into the through-bore of the workpiece, in such a way that, in the predefined, intended mounting position of said first and second perforated disks and in the relaxed state of said first and second perforated disks, a predefined spacing greater than zero is formed between two opposite end sides of said tubular first and second sleeves, said two opposite end sides being disposed in the through-bore of the workpiece.

21. The device according to claim 20, wherein said predefined spacing between said opposite end sides of said tubular first and second sleeves, said opposite end sides being disposed in the through-bore of the workpiece, and free spaces in the radial direction with respect to the axes of the through-bores through said first and second perforated disks are predefined in mutual dependence and in further dependence on strengths of said first and second perforated disks and on a predefined preload force applied by means of said screw or said threaded rod.

22. The device according to claim 16, wherein:
said first perforated disk has a protrusion which projects into the through-bore of the workpiece in the predefined, intended mounting position of said first perforated disk; and/or
said second perforated disk has a protrusion which projects into the through-bore of the workpiece in the predefined, intended mounting position of said second perforated disk.

23. The device according to claim 19, wherein:
said first perforated disk has a first washer for abutment to a screw head of said screw or to a threaded member for screwing with said threaded rod, said first washer being disposed, in the predefined, intended mounting position of said first perforated disk, on a side of said first perforated disk opposite said first bearing surface and being firm and bringing about a uniform force introduction of a preload force applied by said screw head or said threaded member into said first perforated disk; and/or
said second perforated disk has a second washer for abutment of said screw head of said screw or of said threaded member for screwing with said screw or said threaded rod, said second washer being disposed, in the predefined, intended mounting position of said second perforated disk, on a side of said second perforated disk opposite said second bearing surface and being firm and bringing about a uniform force introduction of the preload force applied by said screw head or said threaded member into said second perforated disk.

24. The device according to claim 23, wherein:
said first washer and said tubular first sleeve are firmly connected to one another; and/or
said second washer and said tubular second sleeve are firmly connected to one another.

25. The device according to claim 17, wherein:
the spacing from the side surfaces of the first cutout to said first perforated disk in the predefined, intended mounting position and in the relaxed state of said first perforated disk is predefined in dependence on a strength of said first perforated disk such that, in a case of a predefined preload force applied by means of said screw or said threaded rod, said first perforated disk elastically deformed thereby bears against the side surfaces of the first cutout; and/or
the spacing from the side surfaces of the second cutout to said second perforated disk in the predefined, intended mounting position and in the relaxed state of said second perforated disk is predefined in dependence on a strength of said second perforated disk such that, in a case of the predefined preload force applied by means of said screw or said threaded rod, said second perforated disk elastically deformed thereby bears against the side surfaces of the second cutout.

26. The device according to claim 16, wherein the workpiece is produced from a plastic by means of a generative manufacturing method.

27. The device according to claim 26, wherein the workpiece is produced at least partially in a layerwise fashion, wherein layers in a region of the first and second abutment surfaces have a directional component in the axial direction with respect to the through-bore, with a result that a force introduction by said first and second perforated disks mutually preloaded against the workpiece is distributed over various said layers.

28. The device according to claim 16, wherein the workpiece is a cladding part for a vehicle.

29. A vehicle, comprising:
at least one said device according to claim 16.

30. The vehicle according to claim 29, wherein said at least one device is mounted at a location with high, cyclic operating loads.
